(19) United States
(12) Patent Application Publication
(10) Pub. No.: US 2011/0100630 A1
(43) Pub. Date: May 5, 2011

(54) Method of Mitigating Corrosion Rate of Oilfield Tubular Goods

(75) Inventors: Brian A. Evans, The Woodlands, TX (US); Kushal Seth, Houston, TX (US); Allen D. Gabrysch, Houston, TX (US); Patrick A. Kelly, Conroe, TX (US); Donald Nelson Horner, JR., Spring, TX (US)

(73) Assignee: BAKER HUGHES INCORPORATED, Houston, TX (US)

(21) Appl. No.: 12/911,019

(22) Filed: Oct. 25, 2010

Related U.S. Application Data
(60) Provisional application No. 61/257,158, filed on Nov. 2, 2009.

(51) Int. Cl. E21B 43/16; C09K 8/54

(52) U.S. Cl. 166/305.1; 507/272; 507/267; 507/240; 507/268; 507/252

(57) ABSTRACT

Acid-soluble cupric acetate may used in conjunction with potassium iodide to generate cuprous iodide (CuI) as an acid corrosion inhibition aid. A suitable corrosion inhibitor together with the aid protects steel surfaces in an acid environment, for instance, while acid fracturing or matrix acidizing subterranean formations. Cupric acetate monohydrate may be used with an alkali metal iodide salt such as potassium iodide or sodium iodide to generate cuprous iodide in situ in aqueous acid solutions. Use of cupric acetate provides a somewhat delayed reaction rate with potassium iodide to generate the desired product, cuprous iodide, which has very low solubility in acid systems. The method includes delayed and in situ production of cuprous iodide for enhancing performance of commercially available corrosion inhibitors, commonly referred to as intensifying the effect of the corrosion inhibitor (corrosion inhibitor intensifier or simply an intensifier).

### CROSS-REFERENCE TO RELATED APPLICATION

This application claims the benefit of U.S. Provisional Patent Application Ser. No. 61/257,158 filed Nov. 2, 2009.

### TECHNICAL FIELD

The invention relates to methods and compositions for inhibiting corrosion of metals, and, in one aspect, more particularly relates to methods and compositions for inhibiting corrosion of metals in acid environments.

### TECHNICAL BACKGROUND

It is well known that iron and steel surfaces will corrode in the presence of acid environments. While the rate at which corrosion will occur depends on a number of factors, such as the steel alloy itself, the strength and type of acid, the temperature of the environment, the length of contact, etc., some sort of corrosion invariably occurs. Alloy technology has provided materials to withstand the incidental contact of steel with acid, but the corrosion problem is particularly aggravated when there is no choice but to contact steel with acid, as in the case of chemical processing where acids are employed. In instances where the acid is not required to remain pure and where the contact is inevitable, attention has turned toward providing corrosion inhibitors in the acid medium itself to prevent corrosion of the steel surfaces that it must come into contact with, yet still deliver the acid to its ultimate destination.

Specific environments in which an improved corrosion inhibitor would be appreciated include industrial cleaning and hydrocarbon recovery operations. With respect to oil and gas production, it is well known that during the production life of an oil or gas well, the production zone within the well may be chemically treated or otherwise stimulated to enhance the economical production lifetime of the well. A common way of doing this is by acid fracturing or matrix acidizing, whereby a highly acidic solution, generally having a pH of less than about 1, but which may be as high as about 6.9 is injected into the well. Spent acid in return fluids may have a pH of around 3 to 6.9. Because of the acidic nature of the treatment fluid, the production or workover conduit which is utilized in the well in such applications typically encounters considerable acidic corrosion, in the forms of surface pitting, embrittlement, loss of metal component and the like. Mineral acids (inorganic acids), e.g. hydrochloric acid, sulfuric acid, nitric acid, hydrofluoric acid and the like are commonly used in these fluids.

In earlier years of producing subterranean wells, the vast majority of production and workover conduits comprised carbon steels. These steels were utilized either temporarily or permanently in the well, and treatment and/or stimulation fluids were introduced through them into the well. Due primarily to the drilling and completion of many subterranean wells through formations which contain high concentrations of corrosive fluids such as hydrogen sulfide, carbon dioxide, brine, and combinations of these constituents, the production and workover conduits for use in the wells are now made of high alloy steels. The high alloy steels include, but are not necessarily limited to, chrome steels, duplex steels, stainless steels, martensitic alloy steels, ferritic alloy steels, austenitic stainless steels, precipitation-hardened stainless steels, high nickel content steels, and the like.

Various corrosion inhibitors are known, to which are added other components, such as intensifiers, surfactants, oil wetting components, and the like. U.S. Pat. No. 2,758,970 describes derivatives of rosin amines, which are represented by the formula:

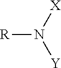

where R is a radical selected from the group consisting of abietyl, hydroabietyl, and dehydroabietyl, Y is the group CH₂R₁, X is a radical selected from the group consisting of hydrogen and CH₂R₁, and R₁ represents alpha ketonyl groups. These rosin amines are noted as useful in reducing the rate of corrosion of metals such as magnesium, aluminum and zinc when they are exposed to the action of a corrosive material such as hydrochloric acid.

Further, U.S. Pat. No. 3,077,454 describes compositions for inhibiting corrosion made by combining certain active hydrogen containing compounds with organic ketones having at least one hydrogen atom on the carbon atom alpha to the carbonyl group and an aldehyde selected from the group consisting of aliphatic aldehydes containing from 1 to 16 carbons, and aromatic aldehydes of the benzene series, having no functional groups other than aldehyde groups, and a fatty acid.

Additionally, Mannich base and thiourea inhibitor compositions and methods of inhibiting the acid attack by aqueous hydrofluoric acid on ferrous metal surfaces, and in particular highly reactive ferrous metal surfaces, are described in U.S. Pat. Nos. 3,992,313 and 4,104,303.

It is also known in the corrosion inhibition art to provide various corrosion inhibition aids (sometimes called corrosion inhibitor intensifiers or simply intensifiers) which are used together with the above and other known corrosion inhibitors. For instance, U.S. Pat. No. 4,871,024 to Cizek (Baker Hughes Incorporated) describes copper metal salt intensifiers and U.S. Pat. No. 4,997,040 to Cizek (Baker Hughes Incorporated) relates to certain acid soluble mercury metal salt intensifiers.

U.S. Pat. No. 3,773,465 concerns an inhibited treating acid for use in contact with ferrous surfaces at temperatures of from about 150° F. to about 450° F. (about 66 to about 232° C.) which contains cuprous iodide (CuI; copper (I) iodide) in a concentration of from about 25 to about 25,000 ppm by weight of the acid. The patent notes that it was discovered that the cuprous iodide produced in situ by reactants which also form free iodine will operate in the inventive manner therein, but show a smaller degree of improvement as compared with combining pre-formed cuprous iodide with an acid. Thus, the patent teaches that the most preferred reactants for producing cuprous iodide in situ are those which do not produce free iodine.

It would be advantageous if new aids to known corrosion inhibitors were discovered that would be an improvement over the presently known systems. For example, a corrosion inhibitor in conjunction with a new corrosion inhibitor aid providing a large corrosion inhibiting effect for a small proportion used would be advantageous. There also remains a need for new corrosion inhibitor aids and methods of use therefore which would work in halogen acid environments for a wide variety of metals, particularly iron alloys such as steels.

### SUMMARY

There is provided, in one non-limiting embodiment, an aqueous acidic composition that includes water, an acid, a corrosion inhibitor, and a mixture to generate a corrosion inhibitor aid in situ in the composition. The mixture includes a copper salt and an alkali metal iodide salt, such as potassium iodide.

Further in another non-restrictive version, there is provided a method of mitigating metal corrosion that involves creating an aqueous acidic composition which includes water, an acid, a corrosion inhibitor, and a mixture to generate a corrosion inhibitor aid in situ. The latter mixture may include a copper salt and an alkali metal iodide. During or after creation of the aqueous acidic composition, the aqueous acidic composition contacts a metal, for instance tubular goods in a wellbore. The copper salt and potassium iodide form cuprous iodide (CuI) in the aqueous acidic composition.

There is additionally provided, in other non-limiting embodiments, methods of acidizing a subterranean formation which involve creating an aqueous acidic composition including water, an acid, a corrosion inhibitor, and a mixture to generate a corrosion inhibitor aid in situ. Again, the mixture may include a copper salt and an alkali metal iodide. During or after creation of the aqueous acidic composition, the aqueous acidic composition is introduced into the subterranean formation through a wellbore. The copper salt and potassium iodide form cuprous iodide (CuI) in the aqueous acidic (CuI) composition.

### DETAILED DESCRIPTION

It has been discovered that acid-soluble cupric acetate and other copper salts may be used together with an alkali metal iodide salt, e.g. potassium iodide, to generate an acid corrosion inhibition aid that when used in conjunction with a suitable corrosion inhibitor may protect steel surfaces in an acid environments. For example in non-limiting instances the acid environment may include acid fracturing or matrix acidizing subterranean formations with acids, including, but not limited to, hydrochloric acid, formic acid, acetic acid or mixtures thereof. More specifically, it was discovered that cupric acetate monohydrate may be reacted with iodide salts to generate cuprous iodide in situ. The use of cupric acetate provides a somewhat delayed reaction rate with iodide salts to generate the desired byproduct, specifically cuprous iodide, which has very low solubility in acid systems. The compositions and methods herein aim at a delayed and in situ production of cuprous iodide for enhancing performance of commercially available corrosion inhibitors, a phenomenon commonly referred to as intensifying the effect of the corrosion inhibitor (where the species involved are known as corrosion inhibitor intensifiers or simply intensifiers). Since cupric acetate is a salt of a weak acid, the reaction with KI is slow enough to delay the formation of cuprous iodide in situ. The delay in the reaction product could also be due to the formation of complex I₂ and I₃⁻ ions (triiodide anion) of potassium iodide in the solution.

In an oilfield context, the corrosion inhibitor formulation may be pumped with the well treating acid at a sufficient concentration to coat the well tubulars and equipment. The concentration of these acid corrosion inhibitors in the acid solution could be in the range of 0.01 to 5.0% wt % of the acids. In one non-limiting embodiment, the iodide salt (such as potassium iodide) may be premixed in the acid and the cupric acetate is added on the fly giving it sufficient time to generate cuprous iodide to coat the tubulars downhole.

In one non-restrictive version, an objective of the compositions and methods described herein is to generate cuprous iodide in a remote location, including, but not limited to, a wellbore to aid in inhibiting or preventing acid corrosion on the steel or alloy wellbore tubulars placed downhole. Adding already-formed cuprous iodide is problematic. When cuprous iodide powder is added directly to an acid, it does not have sufficient solubility to make its use practical. Generating cuprous iodide from the reaction of iodide salt, such as potassium iodide, and cupric acetate when mixed on the fly at or near the wellhead has been discovered to generate the desired product (cuprous iodide) at a slow enough rate and in small enough quantities to be an effective corrosion inhibitor aid or intensifier. One of the major advantages of this method is that both of the salts i.e. of copper and alkali iodide are completely and easily soluble in the aqueous media.

Suitable copper salts for this method include, but are not necessarily limited to, cupric acetate (copper (II) acetate), copper (II) chloride (cupric chloride), cupric formate, cupric nitrate, copper hydroxide, copper sulfate and combinations thereof. The copper salt is not and does not include a lactam-copper complex.

Suitable iodide salts for this method include, but are not necessarily limited to, potassium iodide, sodium iodide and combinations thereof. As noted, adding pre-formed cuprous iodide was tried, but it has very low solubility in acid.

Because cuprous iodide (CuI) is the desired corrosion inhibition aid, the molar ratio of copper in the copper salt to iodine in the iodide salt should be about stoichiometric, or 1:1. Thus, in a non-limiting example, when the reactants are cupric acetate monohydrate and potassium iodide, the molecular weight of cupric acetate monohydrate is 199.6493 and of potassium iodide is 165.7028, and thus, the mix ratio by molar weight of these two particular components should be about 1.2:1 respectively. The reaction of the copper salt with potassium iodide (KI) occurs spontaneously, but slowly in the expected compositions and systems herein—sufficiently slowly so that the compositions may be introduced into a wellbore and coat the tubulars and other downhole equipment.

The dosage of corrosion inhibitor aid may vary greatly depending on the type of chemistry used, and other factors including, but not necessarily limited to the acid used, the acid strength, tubular metallurgy (the nature of the steel contacted), the temperature of the well system, expected acid exposure time, etc. However, one non-limiting embodiment, the amount of corrosion inhibitor aid in the total aqueous acidic composition (including water, acid and corrosion inhibitor) may range from about 0.1 independently to about 5 wt %, alternatively from about 0.2 independently to about 3 wt %; and in another non-limiting embodiment from about 0.3 independently to about 1.7 wt %. As used herein with respect to ranges, the word “independently” means that any lower threshold may be used together with any upper threshold. In another non-limiting embodiment, a typical dosage of 15 lb (6.8 kg) potassium iodide/1000 gallons (3.8 kiloliters) of acid may be used, along with an equal amount of cupric acetate (approximately 0.17% by weight of solution, assuming a typical acid density of 9 ppg (about 1.1 kg/liter).

The acids that may be inhibited against using the methods and compositions herein include, but are not necessarily limited to, inorganic acids including hydrochloric acid, sulfuric acid, nitric acid, phosphoric acid, hydrofluoric acid and boric acid; as well as organic acids selected from the group consisting of acetic acid, formic acid, lactic acid, citric acid, oxalic acid, sulfuric acids, glycolic acid, chloroacetic acid and hydroxyacetic acid and combinations thereof.

Typical acid types and concentrations for well stimulation treatments, include, but are not necessarily limited to the following:

a. Hydrochloric acid in a range of 5 to 28% strength by weight of the solution.

b. Acetic acid in a range of 1 to 15% strength by weight of the solution.

c. Formic acid in a range of 1 to 10% strength by weight of the solution.

Hydrofluoric acid in a range of 0.5 to 6% strength by weight of the solution.

e. Various combinations of the above acid systems.

Corrosion inhibitors which may be used with the in situ-formed cupric iodide include, but are not necessarily limited to Mannich reaction products, quaternary amine compounds, acetylenic alcohols and combinations thereof. In one non-limiting embodiment, useful corrosion inhibitor bases are the Mannich reaction products, which may include, but are not necessarily limited to, the materials of U.S. Pat. Nos. 3,077,454; 5,366,643; and 5,591,381. The products of U.S. Pat. No. 3,077,454 can be made with approximately a 50% yield, and they require the presence of a fatty acid, such as a tall oil fatty acid, in one non-limiting embodiment. The text of this patent is incorporated by reference herein. More specifically, the Mannich reaction product may be the product of reaction of
(i) one mole of an ammonia derivative having at least one hydrogen attached to nitrogen and having no groups reactive under the conditions of reaction other than hydrogen,
(ii) from 1.5 to 10 moles of a carbonyl compound having at least one hydrogen atom on the carbon atom adjacent to the carbonyl group,
(iii) from 2 to 10 moles of an aldehyde different from the carbonyl compound selected from the group consisting of aliphatic aldehydes having from 1 to 16 carbon atoms and aromatic aldehydes of the benzene series and having no functional groups other than aldehyde groups, and
(iv) from 0.6 to 24 parts by weight based on (1), (2), and (3) of an organic acid having from 1 to 20 carbon atoms,
   at a temperature of from about 150° F. (66° C.) to about 250° F. (121° C.) for from about 1 to 16 hours.

One suitable non-limiting Mannich reaction based acid corrosion inhibitor is comprised of the condensation reaction product of 1,3-dibutyl thiourea and acetophenone. Baker Oil Tools CI 200 is a corrosion inhibitors of this type. They contain acetylenic alcohols as well as oxyalkylated alcohol surfactant dispersants, in a co-solvent system containing methanol and fatty acid derivatives.

Baker Oil Tools CI 300 is a suitable quinoline quaternary amine-based acid corrosion inhibitor containing cinnamic aldehyde, as well as oxyalkylated linear alcohol dispersants in a mixed solvent system containing primary alcohols and aromatic naphtha.

Suitable quaternary amine compounds may include, but are not necessarily limited to, the nitrogen-substituted heterocycles of 6 to 10 members quaternized with alkyl halides, also commonly referred to as coal tar based quats. These materials are typically quinolines, pyridines and the like quaternized with alkyl and/or aryl halides, where the alkyl or aryl group may range from methyl to benzyl (C₁ to C₆). Naphthyl quinoline quats are included in this group. Further information may be found with reference to U.S. Pat. No. 2,814,593, incorporated by reference herein in its entirety, which discusses benzyl chloride quats of quinoline.

The mixture to generate a corrosion inhibitor aid may be combined with, added to, injected into, or introduced to any suitable acidic injection medium, including but not necessarily limited to, such media as downhole acidizing fluids and compositions; in non-limiting examples, 15% and 28% concentrations of HCl, 5-15% HCl/Acetic acid blend, to simply name some specific acid compositions. It aids corrosion control at elevated temperatures and pressures with conventional corrosion inhibitors.

Other optional ingredients may be used with the corrosion inhibitor herein, and may include, but are not necessarily limited to, any acetylenic compound such as acetylenic alcohols; cinnamaldehyde; nitrogen compounds, such as a quarternary ammonium compounds; solvents such as alcohols or ketones; and aromatic hydrocarbons or mixtures thereof, as are known to those skilled in the art. For example, teachings from acid corrosion inhibitors as made and described in U.S. Pat. Nos. 3,514,410; 3,404,094; 3,107,221; 2,993,863; and 3,382,179; may be utilized herein. All of these patents are hereby incorporated by reference herein in their entirety. In one non-restrictive embodiment, the corrosion inhibitor contains at least one acetylenic alcohol having from 3 to 10 carbon atoms. In another non-limiting embodiment herein however, the corrosion inhibitor excludes and/or has an absence of acetylenic alcohol.

Examples of acetylenic compounds that may be optionally used include propargyl alcohol (2-propyn-1-ol), hexynol, dimethyl hexynol, diethyl hexynediol, dimethyl hexynediol, ethyl octynol, dimethyl octynediol, methyl butynol, methyl pentynol, ethynyl cyclohexynol, 2-ethyl hexynol, phenyl butynol, and ditertiary acetylenic glycol.

Other acetylenic compounds which can be optionally employed include, but are not limited to, butynediol; 1-ethynylcyclohexanol; 3-methyl-1-nonyn-3-ol; 2-methyl-3-butyn-2-ol; also 1-propyn-3-ol; 1-butyn-3-ol; 1-pentyn-3-ol; 1-heptyn-3-ol; 1-octyn-3-ol; 1-nonyn-3-ol; 1-decyn-3-ol; 1-(2,4,6-trimethyl-3-cyclohexenyl)-3-propyne-1-ol; and in general acetylenic compounds having the general formula:

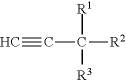

wherein R¹ is —H, —OH, or an alkyl radical; R² is —H, or an alkyl, phenyl, substituted phenyl or hydroxyalkyl radical; and R³ is —H or an alkyl, phenyl, substituted phenyl or hydroxyalkyl radical.

The nitrogen or ammonia compounds that can be optionally employed herein, may include, but are not limited to, those amines having from 1 to 24 carbon atoms in each alkyl moiety as well as the six-membered heterocyclic amines, for example, alkyl pyridines, crude quinolines and mixtures thereof. This includes such amines as ethylamine, diethylamine, triethylamine, propylamine, dipropylamine, tripropylamine, mono-, di- and tripentylamine, mono-, di- and trihexylamine and isomers of these such as isopropylamine, tertiary-butylamine, etc. This also includes alkyl pyridines having from one to five nuclear alkyl substituents per pyridine moiety, such alkyl substituents having from one to 12 carbon atoms, and preferably those having an average of six carbon atoms per pyridine moiety, such as a mixture of high boiling tertiary-nitrogen-heterocyclic compounds, such as HAP (high alkyl pyridines), Reilly 10-20 base and alkyl pyridines H3. Other nitrogen compounds include the crude quinolines having a variety of substituents.

The corrosion inhibitor may also contain a number of other constituents, such as fatty alcohol adducts, nonyl phenol adducts and tallow amine adducts, tall oil adducts, such as surfactants. Oil wetting components, such as heavy aromatic solvents, may also be present. In another non-limiting embodiment, the corrosion inhibitor contains at least one saturated alcohol having from 1 to 5 carbon atoms, and at least one alkyl phenol or alkoxylated alkyl phenol having from 15 to 24 carbon atoms.

Emulsion-preventing surfactants may also be useful to prevent adverse interaction between the acid and the reservoir fluids. Suitable commercial surfactants include, but are not necessarily limited to, Baker Oil Tools NE-100 surfactant. These surfactants may be blends of polyglycols, and may be described as containing 2-ethylhexanol, ethyoxylated alcohol, heavy aromatic naphtha, isopropyl alcohol and methanol. They may contain other proprietary surfactants. Many conventional emulsion-breaking surfactants are derived from polyols, esters or resins, with each family having a particular or specialized function such as speed of oil/water separation, oil/water interface quality and oil carryover in the water phase. Baker Petrolite also sells AQUET™ 946 and AQUET™ AR30 non-emulsifiers. Typical dosages of emulsion-preventing surfactants may range from about 0.1 to about 0.5% by volume of the aqueous acid composition.

It will be appreciated that the compositions and methods herein will have applicability to other industries besides petroleum recovery, including, but not necessarily limited to, water wells, cleaning industrial machinery, pickling steel in acid, pumping acids through pipes, pipelines and other conduits, and other applications where it is desirable to reduce corrosion, such as chemical processes that necessarily require the contact of acids etc. However, the fact that cuprous iodide may be formed in situ is particularly suitable for applications where the aqueous acidic composition must perform at remote locations, such as near the bottom of wellbores and in and near subterranean formations. While the specific implementation of the methods and compositions herein is described in the context of the oil patch, they may certainly find uses in with conduits, fittings, and other equipment in hard to reach locations, such as industrial cleaning applications. It will be appreciated that one of ordinary skill in the art of corrosion inhibition will be able to adapt the teachings herein to applications outside the realm of oil and gas recovery, such as the area of chemical processing, with only routine experimentation.

It will also be appreciated that it is not necessary that corrosion be entirely prevented for the methods described herein to be considered successful, although corrosion prevention is a goal. The methods may be considered successful if corrosion is inhibited or reduced as compared with an identical aqueous acidic composition which does not have a corrosion inhibitor aid generated in situ, as described herein.

In the implementation of the methods and corrosion inhibitors herein in the production of fluids from subterranean reservoirs, a fluid may be introduced through a high alloy steel member or conduit positioned within the well. The corrosion inhibitor herein is introduced, added, or injected into the fluid. As noted, the fluid may contain an acid. The fluid may be an acidic injection medium and in most cases is expected to include an acid corrosion inhibitor. Also included herein are methods of treating a well for enhancement of production within a production zone by introduction or addition into a fluid, particularly one containing an acid, the acid corrosion inhibitor composition herein.

The fluid which is contemplated for use in one non-limiting aspect of the methods and compositions herein for treatment of a subterranean well for enhancement of production will be aqueous based; that is, it will be formed using sea water available at the well location, a brine, tap water or similar fluid. The amount of fluid used for the treatment will vary, of course, from well to well, and will be based upon the particular application at hand, and the amount thereof is not particularly critical to the method.

The expected treatment fluid in an oil production environment is expected to have as a primary additive an acidic injection medium, which may be any compatible acid, including but not limited to hydrochloric acid, hydrofluoric acid, other mineral acids, other halogen acids, even organic acids and mixtures thereof, as described. The fluid with the acid injection medium therein should have a pH of no greater than about 6.9. Acidizing fluids can have pH of less than 1 when mixed with produced fluids, which may have a pH as high as 6.9.

The treatment fluid also contemplates incorporation of other acid corrosion inhibitors, which typically will be provided in treatment concentrations of from about 1,000 ppm, based upon the weight of the entire treatment fluid independently to about 60,000 ppm of such weight. Most often, the total amount of corrosion inhibitors will range from about 1,000 independently to 30,000 ppm. Alternatively the proportions may range from about 0.1% to about 3% by volume of the total aqueous acid solution. The treatment level of the acid corrosion inhibitor will depend upon the particular physical characteristics of the well, the high alloy steel conduit, temperature and pressure considerations, the selected acidic injection medium, and the like.

The compositions and methods may also optionally contain iron control agents to prevent corrosion byproducts from precipitating in the reservoir. The dosage varies with the type of iron control agents used. Suitable iron control agents include, but are not necessarily limited to, citric acid, erythorbic acid and sodium erythorbate, nitrilotriacetic acid (NTA) and salts thereof, ethylene diamine tetraacetic acid (EDTA) and salts thereof, and acetic acid.

Other surfactants to aid in recovering the treating fluids from the reservoir may also be used and are typically present in a dosage of from about 0.1 to about 0.5% by volume. Such surface tension reducing agents to aid in faster recovery of these treating fluids include, but are not necessarily limited to, fluorocarbon surfactants (now obsolete), and alcohol ethoxylate surfactants with blends of solvents.

Mutual solvents may be optionally used to enhance the performance of the acid system. Such mutual solvents are typically used in amounts of from about 5 to 20% by volume of the solution.

In particular, it will be appreciated that the treatment level of the acid corrosion inhibitor will vary depending upon a wide variety of complex, interrelated parameters including, but not limited to, the particular physical characteristics of the system or well, the nature of the steel, temperature and pressure considerations, the acid and strength thereof in the system, acid contact time and the like. Nevertheless, to give a sense of the typical proportions that might be used, non-limiting effective amounts of the corrosion inhibitor ranges from about 0.1 to about 50 gpt (gallons of inhibitor per thousand gallons of acid), depending on the acid strength. (This could also be expressed as 0.1 to 50 lpt—liters per thousand liters of acid.)

The invention will be described further in the following illustrative Examples, which are non-limiting and serve only to further illuminate the invention.

### Example 1

Two different blends were formulated, all percents are volume percents:

Blend #1: 15% HCl+2% CI 300+25 pptg (3 kg/m³) CII 107+15 pptg (1.8 kg/m³) FE 120+2 gptg ST 102+2 gptg NE 100+5% MS-90

Blend #2: 15% HCl+2% CI 300+15 pptg (1.8 kg/m³) FE 120+2 gptg ST 102+2 gptg NE 100+5% MS-90+20 pptg (2.4 kg/m³) CII 107+20 pptg (2.4 kg/m³) CII 109

### CI 300—Corrosion Inhibitor

### CII 107—Potassium Iodide

FE 120—Iron control agent
ST 102—Surface tension reducing agent

### NE 100—Non Emulsifier

### MS 90—Mutual Solvent

### CII 109—Cupric Acetate Monohydrate

Acid Blends #1 and #2 were tested on four different alloys with the results shown in Table I. It may be seen that the inventive additive Blend #2 inhibited corrosion to a much greater extent than did Blend #1 without CII 109. The quantities of the metal loss are expressed in lbs/ft² (kg/m²).

TABLE I
Comparison of Blends #1 and #2 on Four Metal Alloys

| | Temperature 220° F. (104° C.) for 24 hrs | |
|---|---|---|
| Type of Metal | Acid Blend #1 | Acid Blend #2 |
| SM 13 Cr | 0.2378 (1.161) | 0.0080 (0.039) |
| 13 Cr S110 | 0.4163 (2.032) | 0.0318 (0.155) |
| 2205 Duplex | 0.0604 (0.295) | 0.0225 (0.110) |
| 316 SS | 0.0032 (0.016) | 0.0019 (0.009) |

### Example 2

Two additional, different blends were formulated. Again, all percents are volume percents:

Blend 3: 5% HCl+13% Acetic+9% Formic+0.2% AG-195+2% FE-125L+0.2% NE-100+2% CI-300+0.5% BI-100

Blend 4: 5% HCl+13% Acetic+9% Formic+0.2% AG-195+2% FE-125L+0.2% NE-100+2% CI-300+0.5% BI-100+15 pptg CII 107+15 pptg CII 109

AG-195—Acid friction reducer and/or gelling agent
FE-125L—Iron control agent
BI-100—H2S scavenger

Acid Blends 1 and 2 were tested on alloys VM 22 with the results shown in Table II. It may be seen that the inventive additive Blend #2 inhibited corrosion to a much greater extent than did Blend #1 without CII 109. Again, the quantities of the metal loss are expressed in lbs/ft² (kg/m²).

TABLE II
Corrosion Testing on VM 22

| | Temperature 300° F. (149° C.) | |
|---|---|---|
| | for 10 hrs at 400 psi (2.8 MPa) | |
| | Corrosion Loss lbs/sq ft (kg/m²) | |
| Type of Metal | Acid Blend 3 | Acid Blend 4 |
| VM 22 | 0.0164 (0.080) | 0.0025 (0.012) |

The compositions herein have been found to have excellent stability, thus avoiding degradation over time. These corrosion inhibitors will be cost effective and provide excellent corrosion control.

Many modifications may be made in the present invention without departing from the spirit and scope thereof that are defined only by the appended claims. For example, certain components per se, or combinations of components thereof other than those specifically set out herein may be found by one of routine skill in the art to be particularly advantageous, e.g. different combinations of corrosion inhibitor bases with different acids, with certain optional solvents and/or optional acids, surfactants and/or dispersants, etc. other than those mentioned or exemplified are expected to be useful. Additionally, different copper salts and different proportions of reactants may produce corrosion inhibitor aids having particular efficacy.

The words “comprising” and “comprises” as used throughout the claims is interpreted “including but not limited to”.

The present invention may suitably comprise, consist or consist essentially of the elements disclosed and may be practiced in the absence of an element not disclosed. For instance, in one non-limiting embodiment, an aqueous acidic composition may consist essentially of water, an acid, a corrosion inhibitor, and a mixture to generate a corrosion inhibitor aid in situ in the composition. The mixture includes a copper salt and potassium iodide. In another non-restrictive version, an aqueous acidic composition may consist of water, an acid, a corrosion inhibitor, and a mixture to generate a corrosion inhibitor aid in situ in the composition, wherein the mixture is as previously noted.

What is claimed is:

1. An aqueous acidic composition comprising:
water;
an acid;
a corrosion inhibitor; and
a mixture to generate a corrosion inhibitor aid in situ, the mixture comprising:
a copper salt; and
an alkali metal iodide salt selected from the group consisting of potassium iodide, sodium iodide, and combinations thereof.

2. The aqueous acidic composition of claim 1 where the copper salt is selected from the group consisting of cupric acetate, copper (II) chloride, cupric formate, cupric nitrate, copper hydroxide, copper sulfate and combinations thereof.

3. The aqueous acidic composition of claim 1 where the copper salt and the alkali metal iodide salt are present in approximately a 1:1 stoichiometric ratio of copper to iodine.

4. The aqueous acidic composition of claim 1 where the corrosion inhibitor aid is present in the aqueous acidic composition in an amount from about 0.1 to about 5 wt %.

5. The aqueous acidic composition of claim 1 where the acid is selected from the group consisting of:
inorganic acids selected from the group consisting of hydrochloric acid, sulfuric acid, nitric acid, phosphoric acid, hydrofluoric acid, hydrobromic acid, boric acid,
organic acids selected from the group consisting of acetic acid, formic acid, lactic acid, citric acid, oxalic acid, sulfonic acids, glycolic acid, chloroacetic acid, hydroxyacetic acid and
combinations thereof.

6. The aqueous acidic composition of claim 1 where the corrosion inhibitor is selected from the group consisting of acetylenic alcohols, Mannich reaction products, quaternary amine compounds, cinnamaldehyde, and combinations thereof.

7. The aqueous acidic composition of claim 1 where the corrosion inhibitor aid is cuprous iodide (CuI).

8. A method of mitigating metal corrosion comprising:
creating an aqueous acidic composition comprising:
water;
an acid;
a corrosion inhibitor; and
a mixture to generate a corrosion inhibitor aid in situ, the mixture comprising:
a copper salt; and
an alkali metal iodide salt selected from the group consisting of potassium iodide, sodium iodide and combinations thereof;
during or after creation of the aqueous acidic composition, contacting the aqueous acidic composition with a metal; and
forming cuprous iodide (CuI) from the copper salt and the alkali metal iodide salt in the aqueous acidic composition.

9. The method of claim 8 where the copper salt is selected from the group consisting of cupric acetate, copper (II) chloride, cupric formate, cupric nitrate, copper hydroxide, copper sulfate and combinations thereof.

10. The method of claim 8 where the copper salt and the alkali metal iodide salt are present in the aqueous acidic composition in approximately a 1:1 stoichiometric ratio of copper to iodine.

11. The method of claim 8 where the corrosion inhibitor aid is present in the aqueous acidic composition in an amount from about 0.1 to about 5 wt %.

12. The method of claim 8 where the acid is selected from the group consisting of:
inorganic acids selected from the group consisting of hydrochloric acid, sulfuric acid, nitric acid, phosphoric acid, hydrofluoric acid, hydrobromic acid, boric acid,
organic acids selected from the group consisting of acetic acid, formic acid, lactic acid, citric acid, oxalic acid, sulfonic acids, glycolic acid, chloroacetic acid, hydroxyacetic acid and
combinations thereof.

13. The method of claim 8 where the corrosion inhibitor is selected from the group consisting of acetylenic alcohols, Mannich reaction products, quaternary amine compounds, cinnamaldehyde, and combinations thereof.

14. The method of claim 8 where the metal is within a subterranean well and the method further comprises introducing the aqueous acidic composition into the well.

15. A method of acidizing a subterranean formation comprising:
creating an aqueous acidic composition comprising:
water;
an acid;
a corrosion inhibitor; and
a mixture to generate a corrosion inhibitor aid in situ, the mixture comprising:
a copper salt; and
an alkali metal iodide salt selected from the group consisting of potassium iodide, sodium iodide and combinations thereof;
during or after creation of the aqueous acidic composition, introducing the aqueous acidic composition into the subterranean formation through a wellbore; and
forming cuprous iodide (CuI) from the copper salt and the alkali metal iodide salt in the aqueous acidic composition.

16. The method of claim 15 where the copper salt is selected from the group consisting of cupric acetate, copper (II) chloride, cupric formate, cupric nitrate, copper hydroxide, copper sulfate and combinations thereof.

17. The method of claim 15 where the copper salt and the alkali metal iodide salt are present in the aqueous acidic composition in approximately a 1:1 stoichiometric ratio of copper to iodine.

18. The method of claim 15 where the corrosion inhibitor aid is present in the aqueous acidic composition in an amount from about 0.1 to about 5 wt %.

19. The method of claim 15 where the acid is selected from the group consisting of:
inorganic acids selected from the group consisting of hydrochloric acid, sulfuric acid, nitric acid, phosphoric acid, hydrofluoric acid, hydrobromic acid, boric acid,
organic acids selected from the group consisting of acetic acid, formic acid, lactic acid, citric acid, oxalic acid, sulfonic acids, glycolic acid, chloroacetic acid, hydroxyacetic acid and
combinations thereof.

20. The method of claim 15 where the corrosion inhibitor is selected from the group consisting of acetylenic alcohols, Mannich reaction products, quaternary amine compounds, cinnamaldehyde, and combinations thereof.
